(19) United States
(12) Patent Application Publication
(10) Pub. No.: US 2002/0178293 A1
(43) Pub. Date: Nov. 28, 2002

(54) Search method

(76) Inventor: Yasuo Fukuda, Kanagawa (JP)

Correspondence Address: ROBIN BLECKER & DALEY, 2ND FLOOR, 330 MADISON AVENUE, NEW YORK, NY, 10017, US

(21) Appl. No.: 10/145,205

(22) Filed: May 14, 2002

(30) Foreign Application Priority Data
May 24, 2001 (JP) 155610/2001(PAT)

(51) Int. Cl. G06F 15/16

(52) U.S. Cl. 709/248

(57) ABSTRACT

A client displays a plurality of images and designates as a search condition a time corresponding to an image selected from the displayed images. The client transmits a present time at the client and the search condition to a server. The server corrects the search condition in accordance with a time difference between the present time at the server and the present time at the client, and searches image data by using the corrected search condition. The server adjusts a time related to the searched image data in accordance with the time difference between the present times of the server and client, and transmits the image data together with the adjusted time to the client.

### BACKGROUND OF THE INVENTION

1. Field of the Invention

The present invention relates to a search method to be used between devices having a time generating function and a communication function.

2. Related Background Art

If photographs taken with a film type camera are to be presented to another person, prints are checked and desired prints are again printed to give them to the person.

With a recently prevailing digital camera, instead of presenting prints, electronic image data generated by the digital camera is presented in many cases.

If picked-up image data is displayed on a small liquid crystal display of a digital camera, a browsing performance is very poor as compared to browsing it by transferring it to a personal computer.

In order to solve this problem, a large number of images may be searched or filtered by using some criterion. For example, one of search criteria is time.

Some digital camera can store image data in correspondence with a photographed time.

However, there arises a problem that there is no guarantee that the time generated by a digital camera is correct.

If an image picked up at about 12:00 is searched now at about 14:00 from a digital camera whose present time is 15:00, the image at about 12:00 was picked up actually about 11:00.

If the timer of a server is in advance of the timer of a client by one hour and the client requests to search an image at 12:00, then the server searches the image at 11:00.

A search considering a time difference is disclosed, for example, in Japanese Patent Application Laid-Open No. 11-261975.

According to Japanese Patent Application Laid-Open No. 11-261975, a search is performed by adjusting a program time written in a television program guide contained in a teletext signal by using a difference between time information at the broadcasting station contained in the header of the teletext signal and time information at the receiving device.

With this method, however, it is necessary for the contents holding side to transmit a list of contents to a requesting side. A list of contents contains the contents different from those desired by the requesting side, so that redundant information is also transmitted.

### SUMMARY OF THE INVENTION

It is an object of the invention to enable a server to search data desired by a client user even if there is a difference between times of the server and client.

It is another object of the invention to select a desired image matching a search condition from the search results without transmitting all data in a server to thereby reduce a communication time and cost.

It is still another object of the invention to improve usability of a search operation.

It is a further object of the invention to provide a search method of transmitting a search request including a search condition related to time from a client to a server, searching image data in the server in accordance with the search condition included in the received search request, and returning the search results to the client, wherein the search operation is performed by considering the time difference between the client and server.

Other objects of the invention will become apparent from the following detailed description of preferred embodiments.

### BRIEF DESCRIPTION OF THE DRAWINGS

FIG. 1 is a block diagram showing an example of the structure of an image communication device constituting an image communication system according to the invention.

FIG. 2 is a diagram showing an example of the image communication system according to the invention.

FIG. 3 is a flow chart illustrating the client user operation of the image communication system according to a first embodiment of the invention.

FIG. 4 is a conceptual diagram illustrating the relation between time and device's time and a time period.

FIG. 5 is a schematic diagram showing examples of GUI images to be used for a time period specifying process.

FIG. 6 is a flow diagram illustrating client and server operations and communications.

FIG. 7 is a diagram illustrating an example of a time adjusting process at the server.

FIG. 8 is a diagram showing an example of search results.

FIG. 9 is a flow diagram illustrating client operations of an image communication system according to a second embodiment of the invention.

FIG. 10 is a diagram illustrating a communication procedure for estimating a communication time between a client and a server.

FIG. 11 is a flow diagram illustrating client operations of an image communication system according to another embodiment of the invention.

### DETAILED DESCRIPTION OF THE PREFERRED EMBODIMENTS

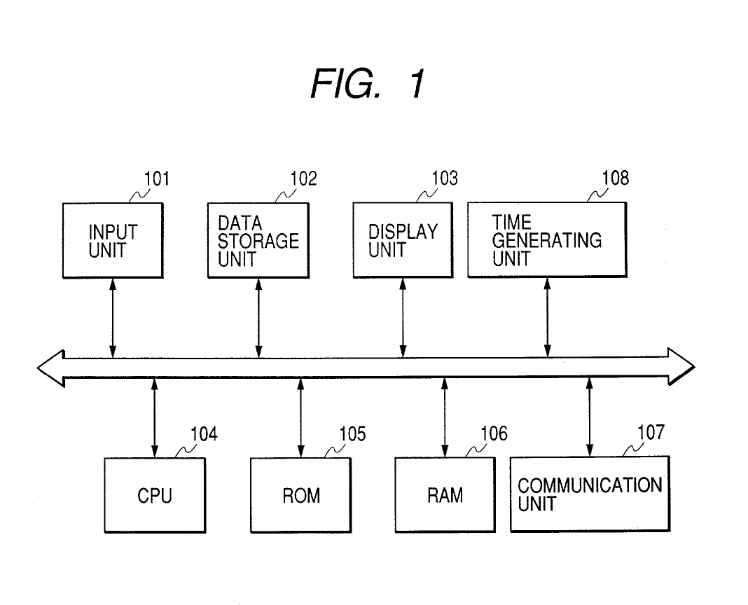

FIG. 1 is a block diagram showing an example of the structure of an image communication device capable of realizing an image communication method according to the invention.

Referring to FIG. 1, an input unit 101 is used for a user to enter an instruction or data, and includes, for example, a keyboard and a poinding device. The pointing device may be a mouse, a track ball, a track pad, a tablet or the like. The pointing device may be a button, a mode dial or the like if the invention is applied to a digital camera.

A data storage unit 102 is used for storing image data, and may be a hard disk, a floppy disk, a CD-ROM, a CD-R, a memory card or the like. The data storage unit 102 may store a program or other data.

A communication unit 107 is used for controlling communications, and may use Ethernet, a modem or the like. A communication method may be wired communications, infrared ray communications, or wireless communications. The communication unit 107 is used for controlling each communication path of these communications.

A display unit 103 is used for displaying an image such as a graphical user interface (GUI) image, and is generally a CRT, a liquid crystal display or the like.

A CPU 104 is concerned with each process to be executed by these units described above.

A ROM 105 and a RAM 106 supply CPU 104 with programs, data and working areas necessary for each process by CPU 104. A control program necessary for a process to be described later is stored in the data storage unit 102. Alternatively, if the control program is stored in ROM 105, it is once read to RAM 106 to thereafter execute it.

A time generating unit 108 is used for holding a value representative of time and updating the value representative of time at a constant time interval (e.g., at each second). It may be configured that a user can change time by using the input unit 102 and display unit 103.

Although not shown, an image input means such as a CCD may be provided to take an image and store it in the data storage unit 102.

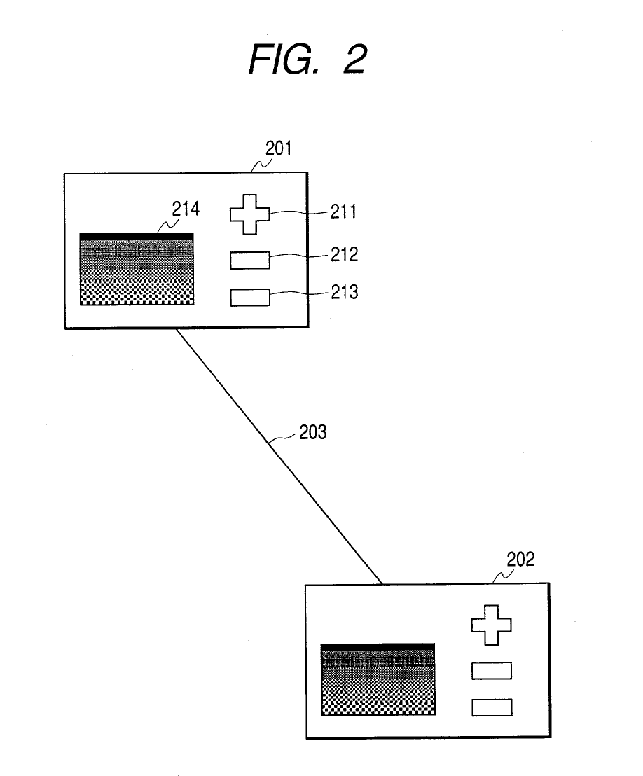

FIG. 2 is a diagram showing an example of an image communication system using an image communication method of the invention.

In the example shown in FIG. 2, image communication devices 201 and 202 having the structure shown in FIG. 1 are connected by a communication path 203.

The communication path 203 is a cable in the case of wired communications, or a conceptual communication path in the case of infrared communications or wireless communications. Although the invention does not depend on a communication path, the communication path 203 is drawn in FIG. 2 for the purposes of description simplicity.

The image communication device 201 has a cross key 211 and buttons 212 and 213 which constitute the input unit 101 shown in FIG. 1. The cross key and buttons are used be way of example only.

In this embodiment, a user operates the image communication device 201 to search images stored in the image communication device 202. This operation will be described by way of example. For the purposes of description simplicity, the image communication device 201 operated by a user is called a client where appropriate and the image communication device 202 storing images is called a server where appropriate, to discriminate therebetween.

With the method of this invention, the display unit and input unit of the server are not essential so that they may be omitted. Contrary to the description of the embodiment, the image communication device 201 shown in FIG. 2 may be a server and the image communication device 202 may be a client.

The client 201 and server 202 each have some image data files in the data storage unit 102. Each image data file of an image is stored together with an image pickup time set by the time generating unit 108.

If the client 201 and server 202 are digital cameras, when an image is picked up by a user, the image data is stored in the data storage unit 102 in the form of file, and an image pickup time acquired from the time generating unit 108 is stored as a time stamp of the image data file.

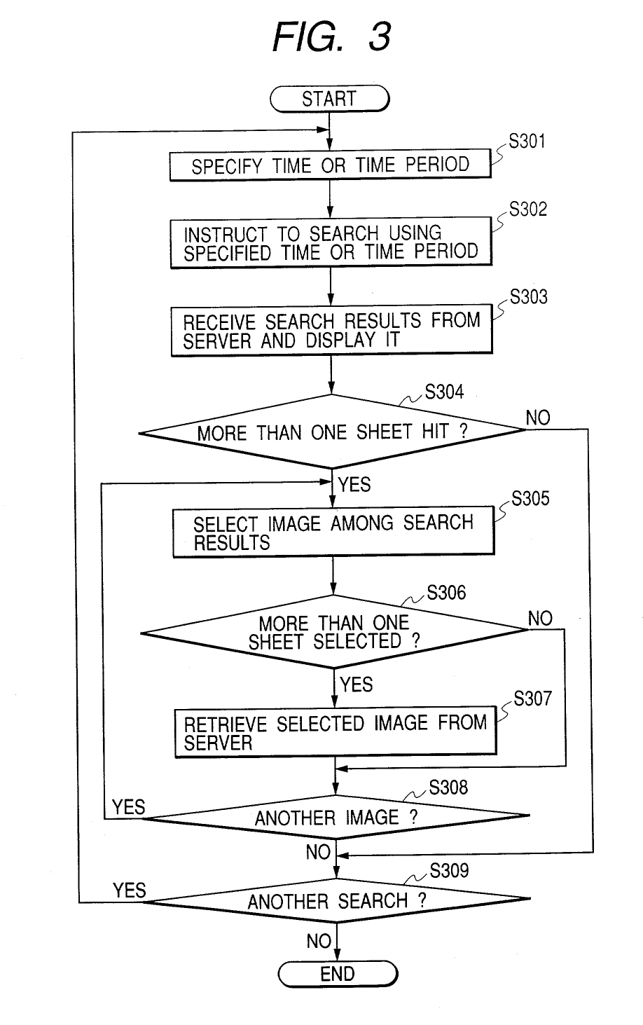

After a user operates GUI of the client 201 to instructs a search and enter a search mode, the user on the client 201 side performs the operations such as shown in FIG. 3.

In the search mode, first at Step S301 the user specifies a time or a time period. In specifying a time, the user enters a value representative of the time from the input unit 102 while viewing a GUI image on the display unit 103.

The user operates the cross key 211 or the like of the input unit 101 to display images or their list stored in the data storage unit 102 of the client 201 on the display unit 103. A time or a time period is then specified by using time or times of a selected image or images (e.g., if the image or images are taken with a digital camera, an image pickup time or times).

If a plurality of images are selected, the time period is a period from the oldest image pickup time to the latest image pickup time.

The image period may also be a predetermined period around the image pickup time of one of the selected image, or a period from a predetermined time before the oldest image pickup time and to a predetermined time after the latest image pickup time.

The term “time” may include information of year, month and day in addition to information of hour, minute and second.

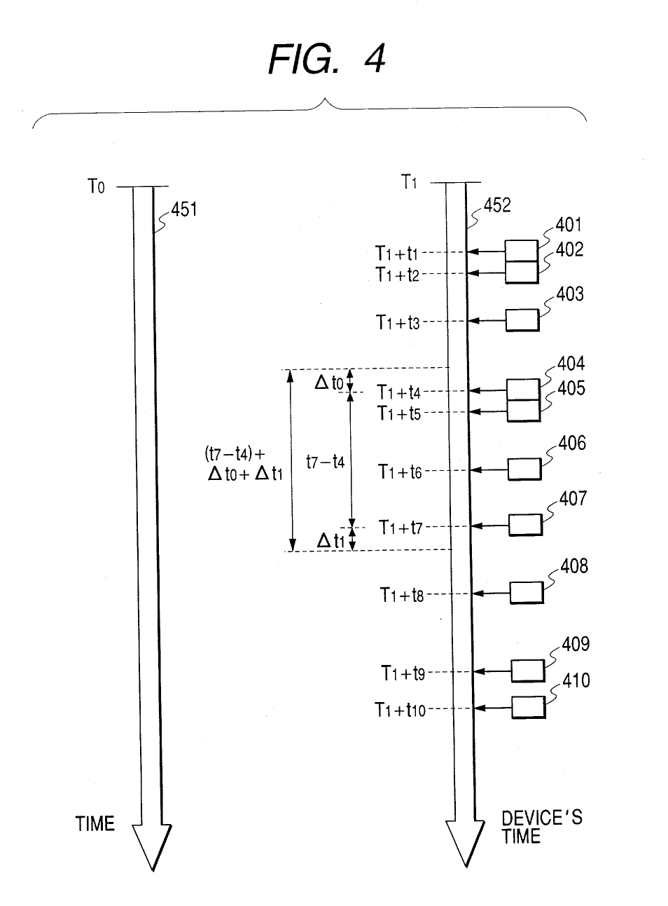

FIG. 4 is a conceptual diagram illustrating the relation between a time and a device's time, and a time period. In FIG. 4, reference numeral 451 represents a correct time, and reference numeral 452 represents a time set by the time generating unit 108 of the client 201. It is assumed that there is a time difference |T₀−T₁| between the correct time 451 and the device's time 452.

Reference numerals 401 to 410 represent image data files of picked-up images at times t₁ to t₁₀ after T₁, respectively. The time stamps of the image data files are represented by (T₁+t₁) to (T₁+t₁₀). These image data files including image data and time data are stored in the data storage unit 102.

If a user selects an image from displayed images or a displayed image list, the device's time 452 can be specified without explicitly giving the user the time. For example, FIG. 4 shows an example of specifying a device's time 452 period (T₁+t₄) to (T₁+t₇) from the image 404 as a start point to the image 407 as an end point.

Alternatively, the time period may be specified by adding some period before and after the time period specified in the above manner.

Fog example, the images 404, 405, 406 and 407 taken by the user correspond to events such as a goal scene of an athletic meeting. All events are not necessarily taken by the user. Namely, a first event was taken after it started or the last event was not taken. In such a case, the user can add offsets (Δt₀ and Δt₁ shown in FIG. 4) to the time period specified by using the images taken by the user.

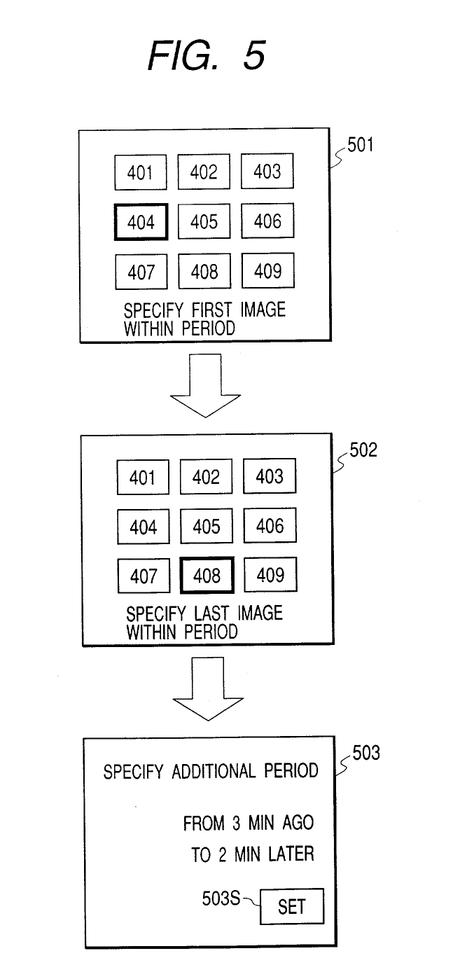

FIG. 5 is a schematic diagram showing examples of GUI images during the time period specifying process.

In FIG. 5, reference numerals 401 to 409 in the GUI images 501 and 502 represent images corresponding to the images 401 to 409 shown in FIG. 4. The GUI images 501 and 502 are displayed on the display unit 103.

When a user specifies the time period, the image list is displayed as the GUI image 501 and the user designates one image as the start point by operating the input unit 101. The GUI image 501 shown in FIG. 5 shows the state that the image 404 is selected.

After the user selects one image as the start point of the time period, the GUI image 502 is displayed to prompt the user to designate the image as the end point. The user selects an image by operating the input unit 101. The GUI image 502 shown in FIG. 5 shows that the image 408 is selected.

If the user selects the image selected in the GUI image 501 in the GUI image 502, the time period is 0.

As the user selects the second image as the end point of the time period in the GUI image 502, a GUI image 503 is displayed to prompt the user to input the front and back offsets of the time period selected in the GUI images 501 and 502. The user sets the desired offset values (from three minutes ago and to two minutes later) by operating the input unit 101. A set button 503S is displayed in the GUI image 503. The user clicks the set button 503S by using the input unit 101 to settle the time period specified in the GUI images 501 to 503.

The GUI images 501 to 503 are used by way of example only. Other GUI images may also be used. Although the offset values in minute is used in the GUI image 503, other time units such as hour and second may also be used. This time values may be preset or the system may set as desired.

With the above-described operation sequence, specifying the time at Step S301 is settled.

Next, the user operates the input unit 101 to instruct a search operation (Step S302). In this case, an operation of searching the image at a specified time or images in the specified time period is instructed. In the example shown in FIG. 2, the server 202 is instructed to perform the search operation. The communication procedure and the processes on the server 202 side will be later described.

Next, the client 201 receives the search results from the server 202 and displays them (Step S303). For example, the identifier of an image on the server 202 side, e.g., the image file name, is displayed on the display unit 103. If the server 202 has no corresponding image, a message such as “no corresponding image” is displayed to notify this effect to the user.

At Step S304 the flow advances in accordance with the search results received at Step S303. If the search results received from the server 202 indicate that there is no corresponding image, the flow skips to Step S309, whereas if not, the flow advances to Step S305.

At Step S305 the user selects images to be actually received from the server 202. To this end, the user operates the input unit 101 to select desired images from the search results displayed at Step S303. Alternatively, without any operation by the user, all images may be selected automatically.

At Step S306 the flow advances in accordance with the user selection at Step S305. If the user selects one or more images, the flow advances to Step S307 to perform an image communication process and acquire the selected images from the server 202. If the user selects no image, Step S307 is skipped to advance to Step S308.

At Step S308 it is judged whether Steps S305 to S307 are executed again for the search results received at Step S303. To this end, a message is displayed on the display unit 103 to prompt the user to determine whether Steps S305 to S307 are executed again in response to the operation of the input unit 101. If Steps are to be executed again, the flow returns to Step S303, whereas if not, the flow advances to Step S309.

Lastly at Step S309 it is judged whether the search process is executed again. In accordance with this judgement, the flow advances. Similar to Step S308, a message is displayed to prompt the user to enter an instruction. If the search process is to be executed again, the flow returns to Step S301, whereas if not, the search process illustrated in the flow chart of FIG. 3 is terminated.

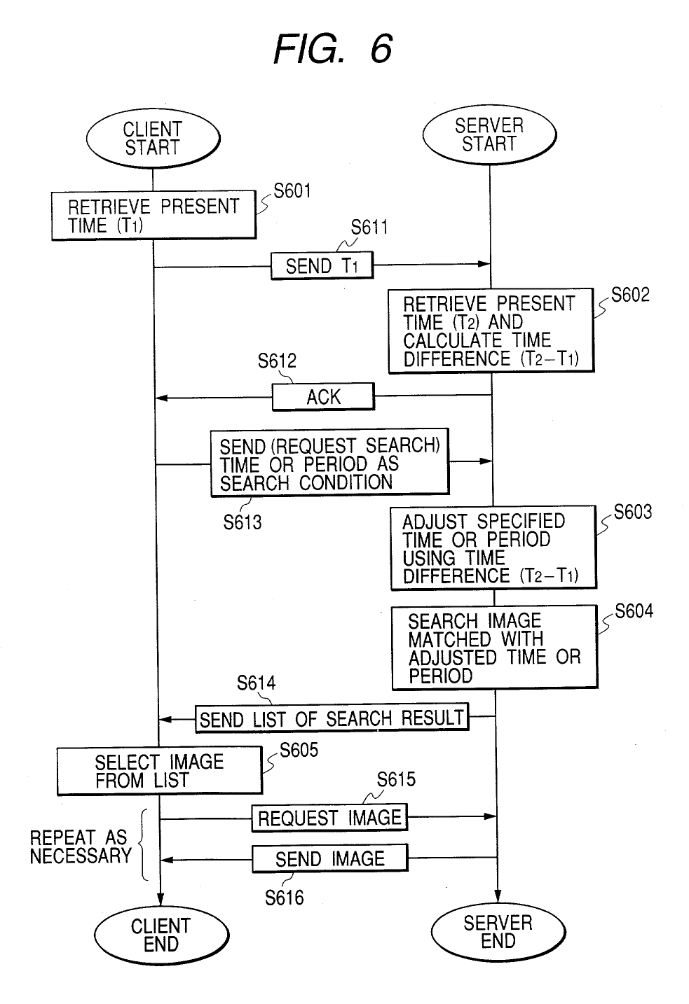

FIG. 6 is a flow diagram illustrating the processes to be executed by the client 201 and server 202 and the communications therebetween.

The client 201 and server 202 perform the following operations under the control of CPU's 104. The data storage unit 102 or ROM 105 is a storage medium from which CPU 104 can read the control program. The control program may be read into RAM 106 via the communication unit 107.

First, the client 201 retrieves the present time T₁ from the time generating unit 108 of the client 201 (Step S601) and immediately transmits T₁ to the server 202 (Step S611).

Next, in response to the transmission of the present time from the client 201, the server 2092 retrieves the present time T₂ from the time generating unit 108 of the server 202, calculates a time difference (T₂−T₁) between the client 201 and server 202, and stores it (Step S602). An ACK signal is returned to the client 201 (Step S612).

Although the time required for communications between the client 201 and server 202 is required to be included in the time difference (T₂−T₁), if the communication speed is sufficiently high, this time can be neglected as an error allowance. Alternatively, the time T₀ required for communications may be considered to set the time difference to (T₂−T₁T₀). This time T₀ may be a fixed value. Considering the time T₀ will be later described.

In response to the ACK signal, the client 201 transmits as the search condition the time or time period to the server 202 (Step S613). This Step S613 corresponds to Step S302 in FIG. 3. The time or time period is specified by the user of the client 201 by using the processes illustrated in FIG. 3 and the GUI images shown in FIG. 5.

The time or time period may be specified by the user after the ACK signal is received from the server 202, or it may be specified before Step S601. The present time of the client 201 may be transmitted to the server 202 when the client 201 instructs the server 202 to perform the search operation, or it may be transmitted periodically or at random timing from the client 201 to the server 202 independently from the instruction of the search operation by the client 201.

The specified time or time period (i.e., the time or time period transmitted from the client 201 to the server 202 as the search condition) is based upon the time retrieved from the time generating unit 108 of the client 201.

In response to the search request, the server 202 adjusts the time or time period contained in the search request by using the time difference calculated at Step S602 (Step S603).

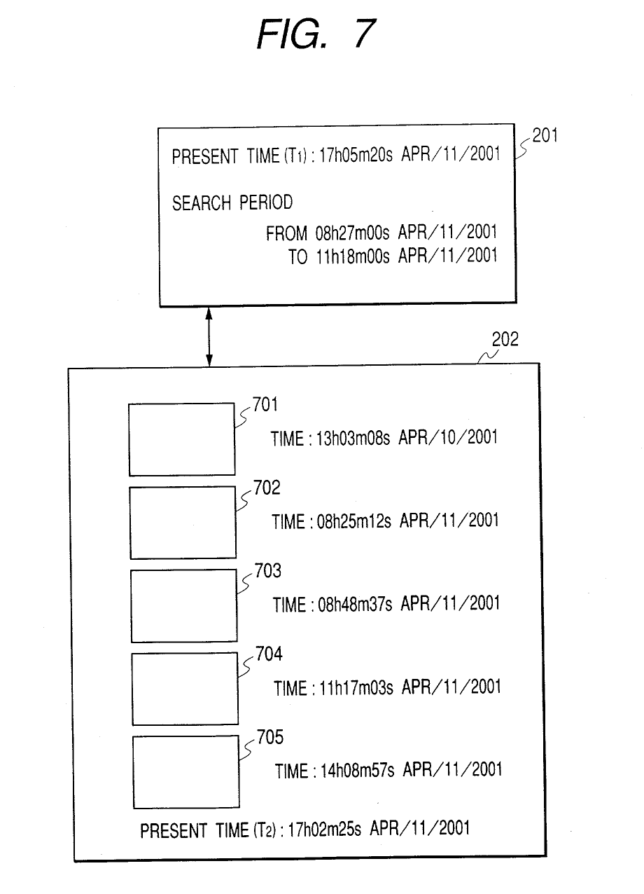

FIG. 7 is a diagram illustrating the time adjusting process.

In the example shown in FIG. 7, the server 202 has five image files 701 to 705 stored in the data storage unit 102 together with the image pickup times. In FIG. 7, the time T₁ at the client 201 is 17 h 05 m 20 s, Apr. 11, 2001 and the time T₂ at the server 202 is 17 h 02 m 25 s, Apr. 11, 2001.

When the present time T₁ of the client 201 is transmitted to the server 202, the server 202 calculates the time difference T_{d}=(T₂−T₁). In the example shown in FIG. 7, the time difference is −2 minutes and 55 seconds. The definition of the time difference is related not so much to whether which one of T₂ and T₁ is a minuend. If the other minuend is used, an addition operation is replaced by a subtraction operation in the time adjusting process to be described below.

It is assumed that the time period included in the search condition specified by the user of the client 201 is from 08 h 23 m 00 s, Apr. 11, 2001 to from 11 h 18 m 00 s, Apr. 11, 2001.

This search condition is the time based upon the time generating unit 108 of the client 201, i.e., the time on the client 201 side, and is not the time based upon the time generating unit 108 of the server 202, i.e., the time on the server 202 side. The time related to each of the images 701 to 705 stored in the server 202 is the time on the server 202 side. Therefore, by utilizing the calculated time difference T_{d}, the time or time period as the search condition is adjusted. Namely, T_{d} is added to the time or time period as the search condition.

Before adjustment: from 08 h 27 m 00 s, Apr. 11, 2001 to 11 h 18 m 00 s, Apr. 11, 2001.

After adjustment: from 08 h 24 m 05 s, Apr. 11, 2001 to 11 h 15 m 05 s, Apr. 11, 2001.

As described above, the time or time period as the search condition is adjusted at Step S603.

Next, at Step S604 an image is searched from the image storage unit 102 by using the adjusted search condition. In the example shown in FIG. 7, since the adjusted search condition is from 08 h 24 m 05 s, Apr. 11, 2001 to 11 h 15 m 05 s, Apr. 11, 2001, the images 702 and 703 are hit. Namely, the server 202 performs the search operation by considering the time difference between the server 202 and client 201. The server 202 returns the search results to the client 201 (Step S614). If the adjustment at Step S603 is not performed, the images 703 and 704 are hit as satisfying the search request of the client 201, which is different from the search results at Step S604 with the adjustment at Step S603.

The search results returned from the server 202 to the client 201 may have any format including at least the identifier (e.g., file name) in the search results.

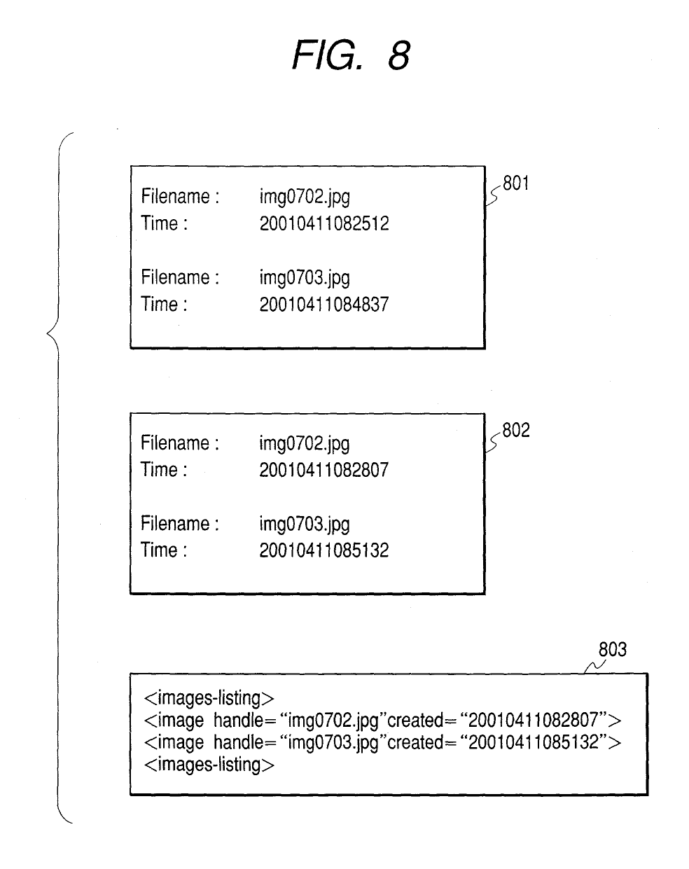

FIG. 8 is a diagram showing examples of the search results returned from the server 202 to the client 201.

A window 801 shows an example of the search results described with FIG. 7. In this example, as the identifiers of the images 702 and 703, image file names img0702.jpg and img0703.jpg are used. Also in this example, in addition to the image identifier, the time related to the image is given. For example, “20010411082512” on the right side of the second row Time in the window 801 means 08 h 25 m 12 s, Apr. 11, 2001.

A window 802 shows the same search results as in the window 801, excepting that the time of the search result image adjusted by using the time difference T_{d} is returned. In the case of the window 802, the server 202 adjusts the time related to img0702.jpg by using the time difference T_{d} (−2 minutes and 55 seconds) to “20010411082807”, i.e., 08 h 28 m 07 s, Apr. 11, 2001.

A window 803 shows the search results as in the window 802 by using the XML format. In this window 803, a tag “image” corresponds to each image of the search results, its identifier is stored as a value of a “handle” attribute, and its related time is stored as a value of a “created” attribute. A tag “images-listing” is used for listing respective tags “image”.

In the above description, the time as the search condition is adjusted. Alternatively, the times of the images 701 to 705 shown in FIG. 7 may be adjusted in accordance with the time difference between the client 201 and server 202 to form a list. In accordance with the search condition sent from the client 201, the time matching the search condition is searched from the list and the corresponding image is used as the search result.

The client 201 received the search results presents the search results to the user to prompt the user to select a desired image (Step S605). This process corresponds to Steps S303 to S305.

Then, the client 201 transmits the image transmission request to the server 202 (Step S615). Namely, the client 201 acquires the identifier of an image selected and transmits an image transmission request together with the image identifier to the server 202.

Upon reception of the image transmission request, the server 202 derives the image identifier out of the request, acquires the image corresponding to the image identifier from the data storage unit 102, and sends the image to the client 101 (Step S616). The transmission request at Step S615 and the transmitted image reception at Step S616 correspond to the image retrieval at Step S307 shown in FIG. 3.

As described above, even there is a time difference between the client 201 and server 202, a user operating the client 201 can search the image at a desired time from the server 202.

In this embodiment, the image identifier and time are returned as the search results. Instead, the user operating the client 201 may be supplied with thumbnail images as the search results.

In order to supply the user with thumbnail images, the following processes are performed.

At Step S614, the server 202 returns thumbnail image data of each image, and the client 201 supplies the user with a list of thumbnail images received at Step S605 to prompt the user to select a desired image.

Alternatively, the client 201 requests a thumbnail image from the server 202 by using the identifier of each image in the received search results, and supplies the received list of thumbnail images to prompt the user to select a desired image.

Alternatively, the server 202 may add a thumbnail image identifier to an identifier of each image of the search results. The client 201 requests the server to send the thumbnail images by using the thumbnail image identifier corresponding to the identifier of each image of the search results, and presents the user with the received list of thumbnail images to prompt the user to select a desired image.

In the above description, although the time adjusting process using the time difference is performed by the server, it may be performed by the client.

Next, the description will be made for the time adjusting process to be executed by the client according to the second embodiment of the invention.

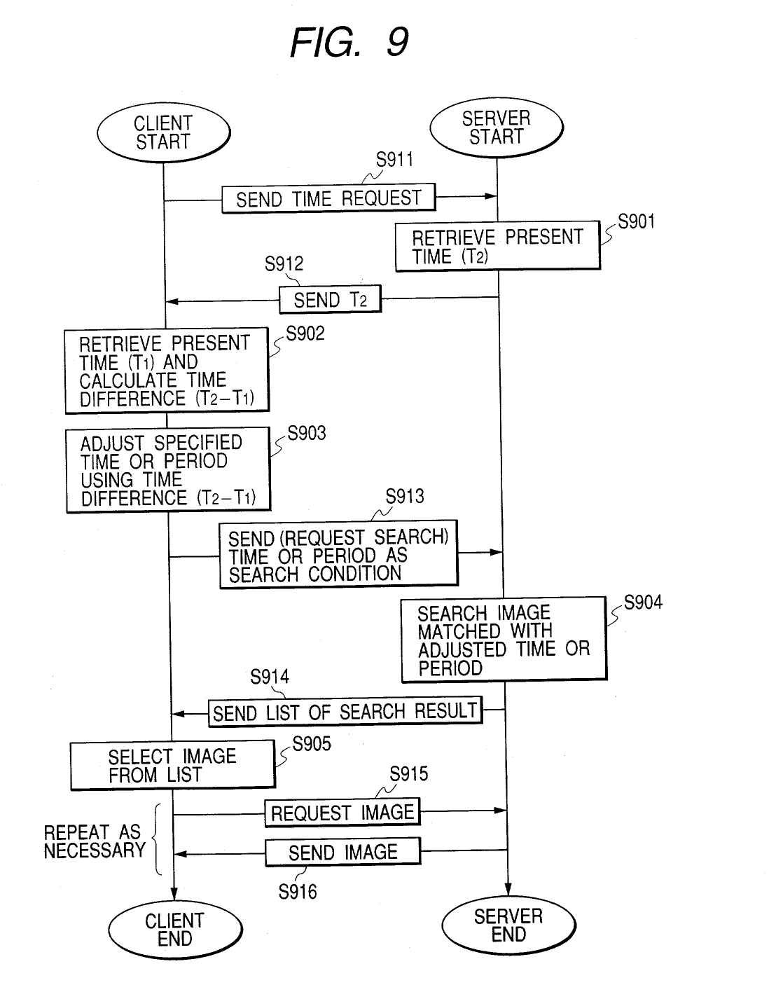

FIG. 9 is a flow diagram illustrating client and server operations and communications according to the second embodiment.

The client 201 and server 202 perform the following operations under the control of CPU's 104. The data storage unit 102 or ROM 105 is a storage medium from which CPU 104 can read the control program. The control program may be read into RAM 106 via the communication unit 107.

Prior to starting the process, first, the client 201 transmits a time request to the server 202 (FIG. 2) (Step S911). The request may be transmitted when the client 201 instructs a search operation or may be transmitted periodically or at random timing independently from the instruction of the search operation by the client 201.

In response to the time request from the client 201, the server 202 retrieves the present time T₂ from the time generating unit 108 (Step S901), and immediately transmits it to the client 201 (Step S912).

Upon reception of the time response from the server 202, the client 201 retrieves the present time T₁ from the time generating unit 108, and calculates the time difference between the client 201 and server 202 (Step S902). Similar to the search operation illustrated in FIG. 6, the time difference may be calculated by considering the time T₀ required for communications between the client 201 and server 202.

A time or time period specified by the user is internally adjusted by using the calculated time difference (Step S903), and a search request is transmitted to the server 202 by using the adjusted time or time period as the search conditions (Step S913). This Step S913 corresponds to Step S302 shown in FIG. 3. Namely, the client requests the search operation by considering the time difference between the server 202 and client 201. Assuming that the search conditions shown in FIG. 7 are specified by the user, the search period “from 08 h 27 m 00 s to 11 h 18 m 00 s” is adjusted to “from 08 h 24 m 05 s to 11 h 15 m 05 s” by using the time difference of −2 minutes and 55 seconds.

In accordance with the received search conditions, the server 202 searches images from the data storage unit 102 (Step S904) and transmits the search results to the client 201 (Step S914).

The client 201 presents the search results to the user. If the server transmits the time information of each image together with the image identifier as shown in FIG. 8, the client 201 corrects the time information of each image by using the calculated time difference (−2 minutes and 55 seconds) and then presents the corrected time information displayed on the display unit 103 to the user. In the example shown in FIG. 7, the time corresponding to the image 702 “08 h 25 m 12 s” is corrected to “08 h 28 m 07 s”, and the time corresponding to the image 703 “08 h 48 m 37 s” is corrected to “08 h 51 m 32 s”.

The user selects a desired image from the corrected search results (Step S905) and transmits an image transmission request to the server 202 (Step S915).

Upon reception of the image transmission request, the server 202 derives the image out of the data storage unit 102 in accordance with the image identifier written in the received request, and sends the image to the client 201 (Step S916). The selection at Step S905, transmission request at Step S915 and transmitted image reception at Step S916 correspond to the display at Step S303, selection at Step S305 and retrieval at Step S307 shown in FIG. 3.

Next, the description will be made for the communication speed between the server and client to be considered when the time difference is calculated.

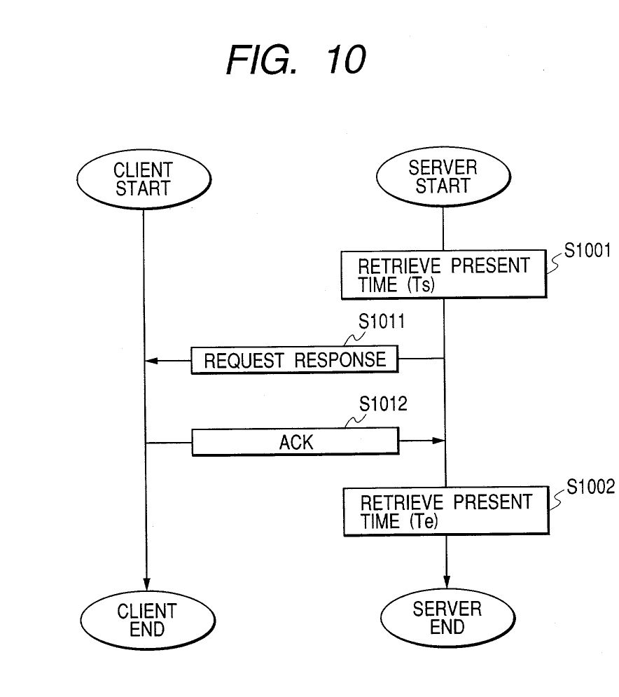

FIG. 10 is a diagram illustrating a procedure of estimating a communication time. FIG. 10 illustrates a communication time estimation to be performed by the server 202. If the communication time is to be estimated at the client 201, the labels of the server 202 and clients 201 are exchanged in FIG. 10.

In the communication time estimation illustrated in FIG. 10, first at Step S1001, the server retrieves the present time Tₛ from the time generating unit 108. Next, the server requests a response from the client (Step S1011). The requested client returns an ACK signal to the server (Step S1012). Upon reception of the ACK signal, the server again retrieves the present time T_{E} (Step S1002).

If the communication speeds from the server to client and vice versa are the same, the communication time is (T_{E}−Tₛ)/2. The time is adjusted by using this communication time and the time difference calculated at Step S602 in FIG. 6 or at Step S902 in FIG. 9.

Even if the communication speeds from the server to client and vice versa are different, the communication time can be estimated by considering the speed ratio.

The processes described with FIG. 10 may be repeated a plurality of times to improve a precision of the communication time through statistical calculations such as averaging.

A precision of the search can further be improved by performing the processes described with FIG. 10, for example, before Step S601 or after Step S602 shown in FIG. 8.

As different from FIG. 6, the processes shown in FIG. 10 are mainly performed by the server. Alternatively, the client may transmit a request for the processes shown in FIG. 10 to the server, and in response to this request, the server performs the processes shown in FIG. 10.

The time may be adjusted by externally supplying a time value to the time generating unit 108 of the server 202.

In adjusting the time value of the time generating unit 108 of the server 202 relative to the time value of the time generating unit 108 of the client 201, for example, a time difference (T_{after}−T_{before}) is calculated and the time value corresponding to each image in the data storage unit 102 is adjusted by using this time difference, where T_{after} is the time value before time adjustment and T_{before} is the time value used for adjustment. The time value used for adjustment is the time value of the time generating unit 108 of the client 201.

In this example, by using the time or time period specified by the user, the image data desired by the client 201 can be searched.

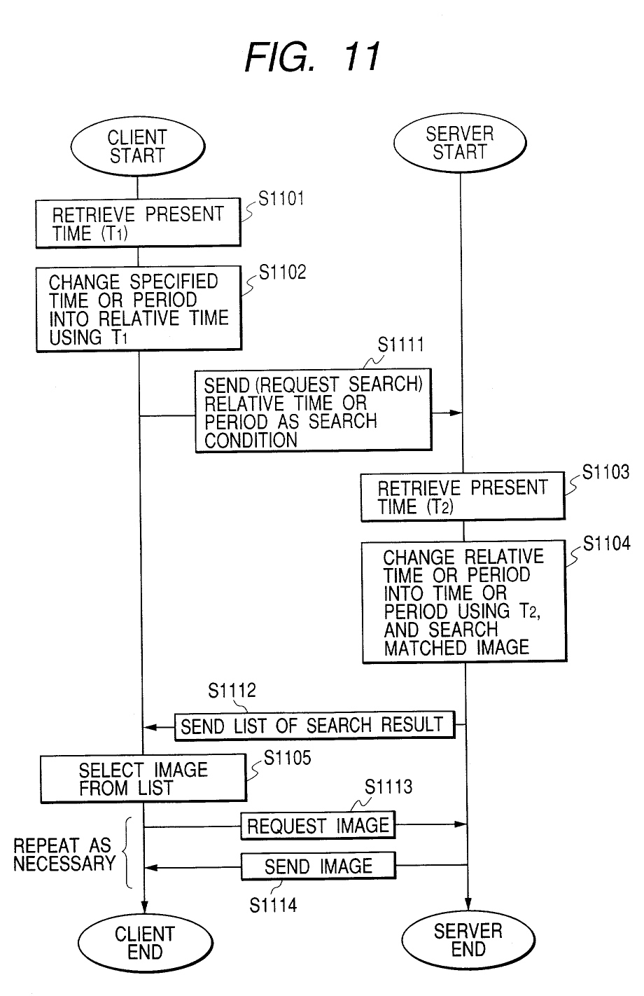

In the example shown in FIG. 9, the client 201 retrieves the time of the server 202 to adjust the time included in the search condition by calculating the time difference between the server and client. Instead, the search condition may use a relative time. This embodiment will be described with reference to FIG. 11.

The client 201 and server 202 perform the following operations under the control of CPU's 104. The data storage unit 102 or ROM 105 is a storage medium from which CPU 104 can read the control program. The control program may be read into RAM 106 via the communication unit 107.

First, the client 201 retrieves the present time T₁ of the time generating unit 108 (Step S1101). Next, the time or time period specified by the user is changed to a relative time or time period by using the time T₁ (Step S1102), and the relative time or time period is transmitted to the server 202 (Step S111). This Step S111 corresponds to Step S302 shown in FIG. 3. In this embodiment, the search is requested by using the relative time or time period.

Upon reception of the search request using the relative time or time period, the server 202 retrieves the present time T₂ of the time generating unit 108 of the server 202 (Step S1103). By using the time T₂, the relative time given in the search request is changed to a normal time to search an image from the data storage unit 102 (Step S1104).

Referring to FIG. 7, if the server 202 stores the times of the image data 701 to 705 as the relative times to the time of the time generating unit 108 of the server 202, it is not necessary for the server 202 to change the relative time to the normal time.

The search results are returned from the server 202 to the client 201 (Step S1112). The client 201 presents the search result list to the user to prompt the user to select a desired image (Step S1105). In accordance with the user selection, the client transmits an image transmission request to the server 202 (Step S1113). In response to the image transmission request from the client, the server retrieves the image from the data storage unit 102 and returns it to the client (Step S1114). The selection at Step S1105, request at Step S1113 and reception of an image transmitted at Step S1114 correspond to the selection at Step S305 and retrieval at Step S307 shown in FIG. 3.

In another example, if the search results include time, the server 202 may change the time of each image in the search results to a relative time by using the time T₂ and return it to the client 201. Upon reception of the search results, the client recovers the normal time by using the time T₁.

In this embodiment, the processes at Steps S1101 to S1105 shown in FIG. 11 are performed for each search operation so that the communications for calculation of the time difference between the server and client is not necessary.

The present invention has been described in connection with the preferred embodiments. The invention is not limited only to the above embodiments, but various modifications are possible without departing from the scope of claims.

What is claimed is:

1. A search method comprising steps of:
specifying a time at a client;
searching data related to the time at a server; and
changing the time to be used for said searching step so as to search the data in accordance with the time specified by the client, a clock unit of the server and a clock unit of the server.

2. A search method according to claim 1, wherein said changing step changes a time corresponding to the searched data in accordance with the clock unit of the client and the clock unit of the server, and the client displays the changed time.

3. A search method according to claim 1, wherein said changing step includes a step of changing the specified time to a relative time to a first clock unit of the client at the client, and the server searches the data in accordance with the relative time to the first clock unit of the client and a second clock unit of the server.

4. A search method according to claim 1, wherein said changing step changes a time in the clock unit of the server and a time related to the data searched by the server.

5. A search system comprising:
receiving means for receiving a search condition from a client;
clock means; and
searching means for searching data in accordance with a time specified by the client, said clock means and the search condition.

6. A search system according to claim 5, wherein said searching means changes a time related to the searched data in accordance with the time specified by the client and said clock means and transmits the changed time to the client.

7. A client comprising:
clock means;
acquiring means for acquiring a first time from a server; and
transmitting means for transmitting a search condition matching the acquired first time and a second time of said clock means to the server.

8. A client according to claim 7, further comprising changing means for changing a time corresponding to a search result received from the server in accordance with the acquired first time and the second time of said clock means.

9. A client comprising:
clock means;
specifying means for specifying a time;
converting means for converting the time specified by said specifying means to a relative time to a time of said clock means; and
transmitting means for transmitting a search condition matching the relative time to a server.

10. A client according to claim 9, further comprising changing means for changing a time corresponding to a search result received from the server in accordance with an acquired first time and a second time of said clock means.

11. A program for a server or a storage medium storing the program, the program comprising steps of:
receiving a search condition from a client; and
searching data in accordance with a time specified by the client, a time at the server and the search condition.

12. A program according to claim 11, wherein said searching step changes a time related to the searched data in accordance with the time specified by the client and the time at the server, and transmits the changed time to the client.

13. A program for a client for transmitting a search condition to a server or a storage medium storing the program, the program comprising steps of:
acquiring a first time from the server; and
transmitting the search condition matching the acquired first time and a second time at the client to the server.

14. A program according to claim 13, further comprising a changing step of changing a time corresponding to a search result received from the server in accordance with the acquired first time and the second time at the client.

15. A program for a client for transmitting a search condition to a server or a storage medium storing the program, the program comprising steps of:
inputting a specified time;
converting the specified time to a relative time to a time at the client; and
transmitting a search condition matching the relative time to the server.

16. A program according to claim 15, further comprising a changing step of changing a time corresponding to a search result received from the server in accordance with an acquired first time and a second time at the server.

17. A client comprising:
display means for displaying data related to a time;
selecting means for selecting the data displayed by said displaying means; and
transmitting means for transmitting a search condition matching the time related to the data selected by said selecting means to the server.

18. A program for a client for transmitting a search condition to a server or a storage medium storing the program, the program comprising steps of:
displaying data related to a time;
selecting the displayed data; and
transmitting a search condition matching the time related to the selected data to the server.
